(19) United States
(12) Patent Application Publication
(10) Pub. No.: US 2018/0107451 A1
(43) Pub. Date: Apr. 19, 2018

(54) AUTOMATIC SCALING FOR FIXED POINT IMPLEMENTATION OF DEEP NEURAL NETWORKS

(71) Applicant: International Business Machines Corporation, Armonk, NY (US)

(72) Inventors: Stefan Harrer, Aampton (AU); Antonio Jose Jimeno Yepes, Parkville (AU); Filiz Isabel Kiral-Kornek, Collingwood (AU); Benjamin Scott Mashford, Malvern East (AU); Jianbin Tang, Doncaster East (AU)

(21) Appl. No.: 15/293,954

(22) Filed: Oct. 14, 2016

(51) Int. Cl. G06F 7/483; G06N 3/08

(52) U.S. Cl. CPC G06F 7/483; G06N 3/08

(57) ABSTRACT

Automatic scaling is performed on a floating point implementation of a DNN to perform scaling to a fixed point implementation. The DNN includes multiple layers in an order from a starting to an ending layer. The automatic scaling includes determining a scaling factor for each of multiple ones of the layers during training of the DNN. The scaling factor converts floating point numbers used for calculations in a layer into integer numbers to be used in the calculations. A scaling factor is determined for a selected layer, which is at a position in the order, based on scaling factors used in layers in the order prior to the position of the selected layer. The automatic scaling includes outputting the scaling factors for the multiple layers to be used for implementing the fixed point implementation of the DNN that uses integer calculations instead of floating point calculations.

### BACKGROUND

This invention relates generally to neural networks and, more specifically, relates to automatic scaling for fixed point implementation of deep neural networks.

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section.

A neural network is a computing solution that is loosely modeled after structures of the brain. A neural network comprises interconnected processing elements called nodes or neurons that work together to produce an output. The neural network is effectively a parallel distributed processing network.

Deep neural networks (DNNs) are an improvement over the original neural networks. DNNs have many layers (e.g., between four and 1,000 or possibly more), and typically involve a huge number of parameters, e.g., from 100 to 1 trillion. DNNs are also quite computationally intensive.

That computational intensity provides benefits. For instance, DNNs have shown significant improvements in several application domains including computer vision and speech recognition. In computer vision, a particular type of DNN, known as a Convolutional Neural Network (CNN), has demonstrated state-of-the-art results in object recognition and detection.

Most DNNs use floating point numbers as the neural network coefficients, and for network input and output. Some neuromorphic chips are using a fixed-point implementation, which use a limited integer range to represent numbers instead of using floating point numbers. Fixed point implementation is easier to implement on single-chip, lower-power semiconductor circuits. However, it can be difficult to convert floating point numbers to fixed point numbers, particularly when the distribution of the floating point numbers is not known in advance. Furthermore, the parameters for DNNs are typically not predictable in advance and vary widely depending on application, and this provides an additional challenge to using fixed point implementations of DNNs.

### BRIEF SUMMARY

This section is intended to include examples and is not intended to be limiting.

In an exemplary embodiment, a method is disclosed for performing automatic scaling on a floating point implementation of a deep neural network to perform scaling to a fixed point implementation of the deep neural network, wherein the deep neural network comprises a plurality of layers in an order from a starting layer to an ending layer and uses floating point calculations in the plurality of layers. The automatic scaling comprises: determining a scaling factor for each of multiple ones of the layers during training of the deep neural network, wherein the scaling factor converts floating point numbers used for calculations in a corresponding layer into integer numbers to be used in the calculations, and wherein determining a scaling factor comprises determining the scaling factor for a selected layer, which is at a position in the order, based on scaling factors used in layers in the order prior to the position of the selected layer; and outputting the scaling factors for the multiple layers to be used for implementing the fixed point implementation of the deep neural network, wherein the fixed point implementation of the deep neural network uses integer calculations instead of floating point calculations.

In another example, an apparatus is disclosed that comprises one or more memories comprising a computer readable program, and one or more processors. The one or more processors are configured, in response to executing the computer readable program, to cause the apparatus to perform operations comprising: performing automatic scaling on a floating point implementation of a deep neural network to perform scaling to a fixed point implementation of the deep neural network, wherein the deep neural network comprises a plurality of layers in an order from a starting layer to an ending layer and uses floating point calculations in the plurality of layers, the automatic scaling comprising: determining a scaling factor for each of multiple ones of the layers during training of the deep neural network, wherein the scaling factor converts floating point numbers used for calculations in a corresponding layer into integer numbers to be used in the calculations, and wherein determining a scaling factor comprises determining the scaling factor for a selected layer, which is at a position in the order, based on scaling factors used in layers in the order prior to the position of the selected layer; and outputting the scaling factors for the multiple layers to be used for implementing the fixed point implementation of the deep neural network, wherein the fixed point implementation of the deep neural network uses integer calculations instead of floating point calculations.

In an additional exemplary embodiment, a deep neural network is disclosed that is formed in circuitry based on a method comprising: performing automatic scaling on a floating point implementation of a deep neural network to perform scaling to a fixed point implementation of the deep neural network, wherein the deep neural network comprises a plurality of layers in an order from a starting layer to an ending layer and uses floating point calculations in the plurality of layers, the automatic scaling comprising: determining a scaling factor for each of multiple ones of the layers during training of the deep neural network, wherein the scaling factor converts floating point numbers used for calculations in a corresponding layer into integer numbers to be used in the calculations, and wherein determining a scaling factor comprises determining the scaling factor for a selected layer, which is at a position in the order, based on scaling factors used in layers in the order prior to the position of the selected layer; and outputting the scaling factors for the multiple layers to be used for implementing the fixed point implementation of the deep neural network, wherein the fixed point implementation of the deep neural network uses integer calculations instead of floating point calculations.

### BRIEF DESCRIPTION OF THE DRAWINGS

In the attached Drawing Figures:

FIG. 1 includes FIGS. 1A, 1B, and 1C, where FIG. 1A is a block diagram of one possible and non-limiting exemplary flow that includes performance of automatic scaling for fixed point implementation of deep neural networks (DNNs) and use of the results of the automatic scaling, where FIG. 1B is an exemplary DNN used in the example of FIG. 1A, and where FIG. 1C illustrates possible implementations used for auto scaling enabled training based on a DNN;

FIG. 2 is a logic flow diagram for multi stage auto scaling enabled training, and illustrates the operation of an exemplary method, a result of execution of computer program instructions embodied on a computer readable memory, functions performed by logic implemented in hardware, and/or interconnected means for performing functions in accordance with exemplary embodiments;

FIG. 3 is a logic flow diagram for updating scaling factors, and illustrates the operation of an exemplary method, a result of execution of computer program instructions embodied on a computer readable memory, functions performed by logic implemented in hardware, and/or interconnected means for performing functions in accordance with exemplary embodiments;

FIG. 4 illustrates an example of multiple stage scaling adjustment.

### DETAILED DESCRIPTION OF THE DRAWINGS

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

State-of-the-art DNNs use float point number for all the network coefficients, input and output. In floating point implementations, each floating point variable typically uses a sign, exponent and mantissa. The value of the floating point variable is calculated using a formula involving that information. Floating point implementations of DNNs can be quite computationally intensive.

To achieve the least cost and energy, by contract some researchers are working on binarizing the input for neural networks, coefficients and activations, and these researchers have achieved initial success on datasets with, e.g., small image size. However, there is significant performance loss for larger image datasets. Hence, using a reasonable width of integers to represent the input, coefficients and activations is still valuable and necessary to reach the state-of-the-art performance as well as achieve the advantage of fixed point implementation.

Fixed point formats typically consist of a signed mantissa and a global scaling factor shared between all fixed point variables. The scaling factor can be seen as a position of a radix point. This position is usually fixed, hence the name “fixed point”. Reducing the scaling factor reduces the range and augments the precision of the format. The scaling factor is typically a power of two for computational efficiency, as the scaling multiplications are replaced with shifts. See, M. Courbariaux, et al., “Training deep neural networks with low precision multiplications”, arXiv:1412.7024, sections 3 and 4 (2015). To reach the best performance, the scaling factor can be any number and does not have to be power of two or an integer.

Scaling is used to adjust the range of a fixed point number to represent the floating point number with minimum performance loss, which is widely used in many industries, for example wireless communication. Usually the best scaling can be pre-calculated if the floating point number's distribution is known. The system's performance is very sensitive to the scaling factor.

However, when dealing with DNNs, this is quite a different story. A DNN itself can automatically match the scaling factor because of its training, which makes the scaling of a DNN more tolerable. There are, however, still limitations. For instance, if the system's behavior can be predicted, then scaling factors can be pre-calculated based on the float number's distribution. However, DNNs' parameters are highly decided by the training and not predictable, and a DNN's best scaling is highly decided by the training and is, thus, difficult to predict. Hence an automatic scheme based on real-time training is needed to improve fixed point performance.

If one wants to deploy DNNs into a FPGA (field-programmable gate array) or an ASIC (application-specific integrated circuit), or a neuromorphic chip, fixed point representation is beneficial to save cost and energy. It is necessary to have techniques for creating such a fixed point representation.

The exemplary embodiments herein provide such techniques and specifically provide systems and methods in exemplary embodiments to enable auto scaling (automatic scaling) for DNN fixed point implementations. It is possible to achieve the best performance of the trained system within the limited accuracy of a fixed point representation. In particular, exemplary methods herein have better performance on getting a smaller fix point bit width than do conventional methods.

Exemplary embodiments herein provide, e.g., a system and method to train a fixed point DNN by enabling auto scaling. With auto scaling, stable accuracy performance as well as low bit-width of fix-point can be achieved. This low bit-width fixed point DNN can be deployed into low power consumption platforms like FPGA, ASIC or some neuromorphic chips. The disclosed methods can be applied to different datasets and different neural networks following the same process.

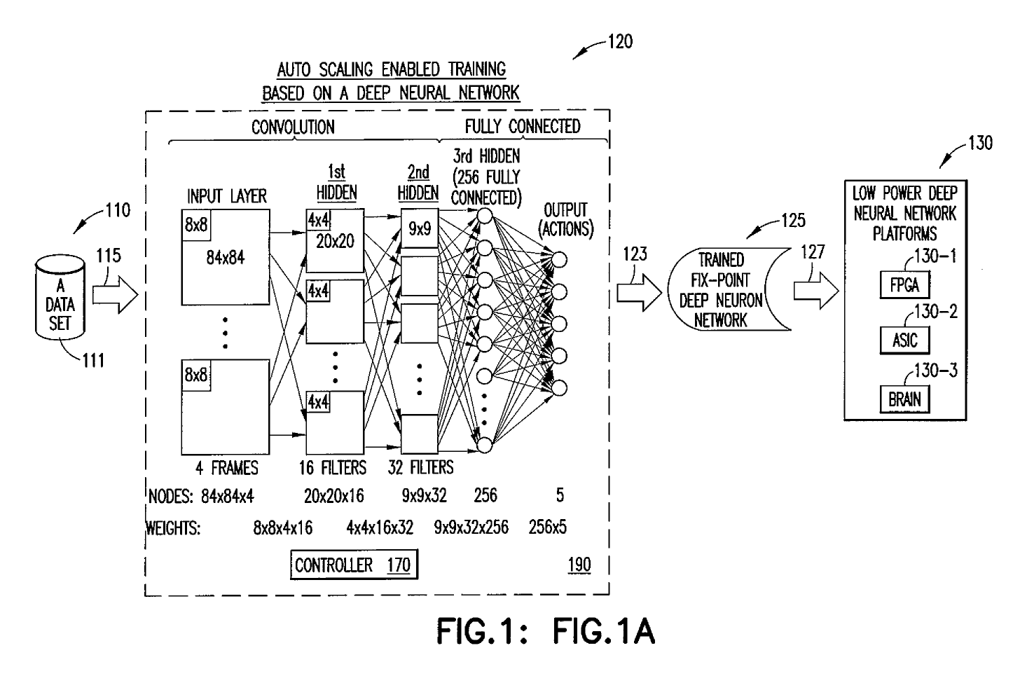

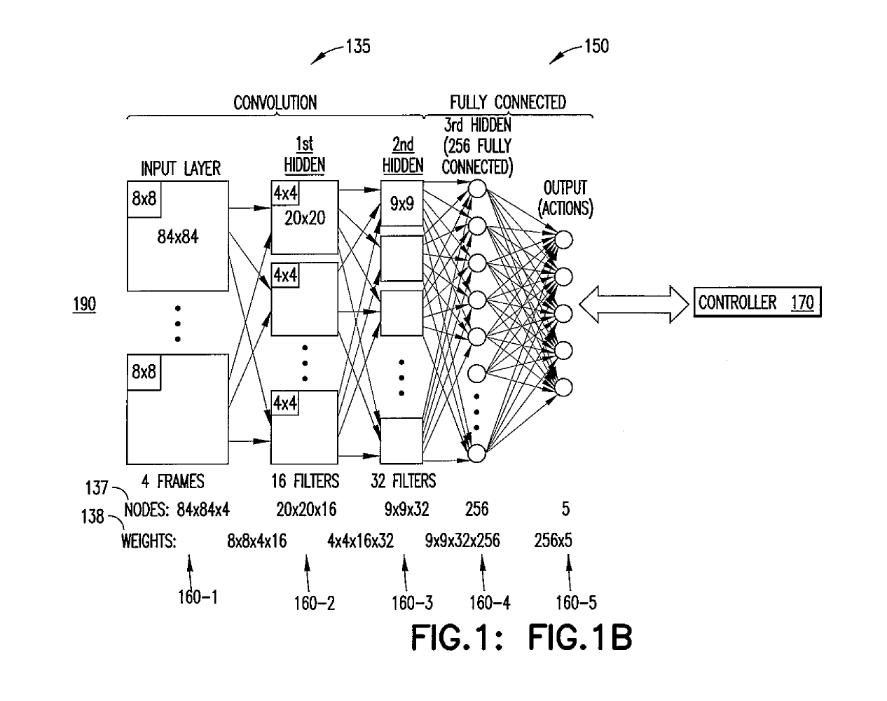

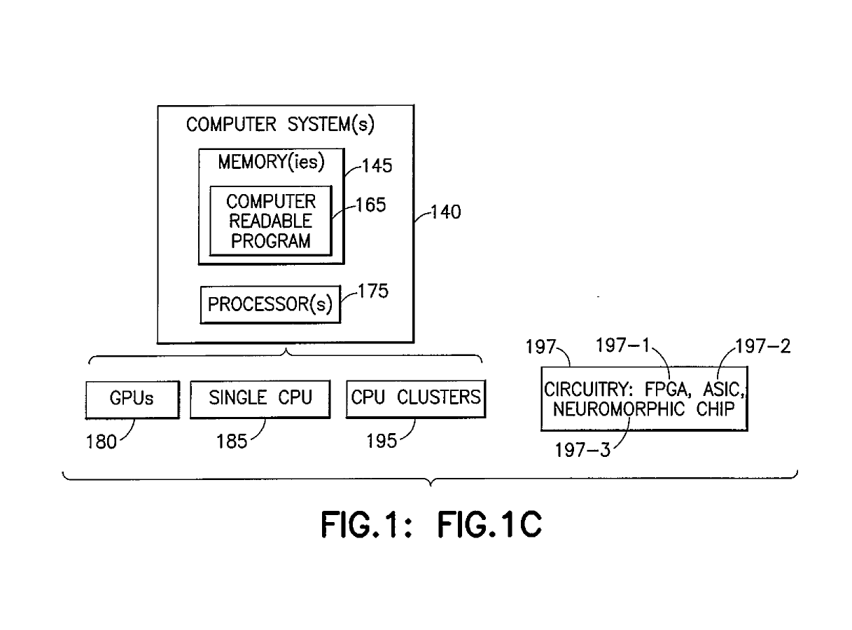

Turning to FIG. 1, this figure includes FIGS. 1A, 1B, and 1C. FIG. 1A is a block diagram of one possible and non-limiting exemplary flow that includes performance of automatic scaling for fixed point implementation of DNNs and use of the results of the automatic scaling. FIG. 1B is an exemplary DNN 190 used in the example of FIG. 1A. FIG. 1C illustrates possible implementations used for auto scaling enabled training based on a DNN 190.

The flow in FIG. 1A of FIG. 1 illustrates broad conceptual operations to perform and use fixed point implementations of DNNs. In operation 115, a dataset 110 (e.g., from a database 111) is applied to a DNN 190. In process 120, auto scaling enabled training is performed based on the DNN 190 and based on techniques presented in more detail below. For the DNN 190, a controller 170 can be implemented that enables the DNN 190 to carry out the training 120 (and other operations) performed herein. The training 120 produces (reference 123) a trained fixed point (or fix-point) DNN, illustrated by reference 125. That fixed point DNN 125 can be deployed (illustrated by reference 127) into a low power DNN platform 130 (i.e., circuitry), such as an FPGA 130-1, an ASIC 130-2, and/or a neuromorphic chip (a semiconductor chip, illustrated as “Brain”) 130-3. The process 127 will remove all the float point operation in the real deployment, the low power DNN platform 130. Only integer operation would be used. Depending on the integer's bit width, the operation can be further simplified. For example, for multiplication can sometimes a multiplier (which is quite expensive, e.g., in area) is needed; but multiplication can also use simpler logic (e.g., shift and add), if the bit width is low. In an extreme case, if the bit width is only one bit, then the multiplication will be performed through AND operation. It is assumed that the process 127 can be performed by one skilled in the art (e.g., in part) and also possibly performed by an automated process. Additionally, creation of the FPGA 130-1, an ASIC 130-2, and/or a neuromorphic chip may be automated in whole or in part.

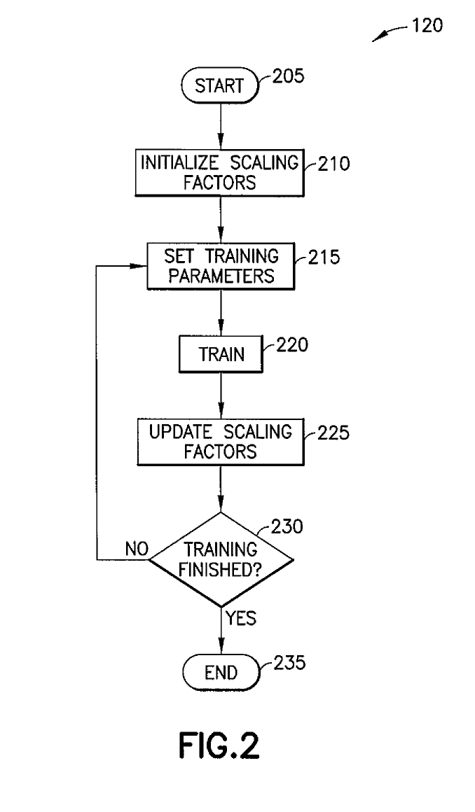

In FIG. 1B of FIG. 1, an exemplary DNN 190 is shown, having two main stages: convolution 135; and fully connected 150. This example DNN is a convolutional neural network, which is a type of feed-forward artificial neural network in which the connectivity pattern between its neurons is inspired by the organization of the animal visual cortex. There are five layers 160-1, 160-2, 160-3, 160-4, and 160-5. Reference 137 lists the nodes in each respective layer and reference 138 lists the weights applied between layers. The input layer 160-4 comprises four frames of 84×84 nodes. The weights 138 applied between the input layer 160-1 and the first (1st) hidden layer 160-2 are 8×8×8×16. The first (1st) hidden layer 160-2 comprises 16 filters of 20×20 nodes, and the weights 138 applied between the first hidden layer 160-2 and the second (2nd) hidden layer 160-3 are 4×4×16×32. The second hidden layer 160-3 comprises 32 filters of 9×9 nodes, and the weights 138 applied between the second hidden layer 160-3 and the third (3rd) hidden layer 160-4 are 9×9×32×256. The third hidden layer 160-4 comprises 256 fully connected nodes, and weights 138 applied between the third hidden layer 160-4 and the output layer 160-5 are 256×5. The output layer comprises five nodes, which are the outputs with corresponding actions. The controller 170 interfaces with the levels and elements (e.g., nodes) of the DNN 190 in order to configure the DNN 190, perform calculations such as statistical calculations, and otherwise cause the DNN 190 to perform the auto scaling operations indicated in FIGS. 2-4 described below.

Referring to FIG. 1C, FIG. 1C illustrates possible implementations used for auto scaling enabled training based on a DNN. In order to perform the auto scaling enabled training for process 120, the DNN 190 typically is simulated. For instance, the structure of the DNN 190 could be simulated using one or more computer systems 140, each comprising one or more memories 145 and one or more processors 175. The one or more memories 145 comprise computer readable code 165 that causes the one or more computer systems 140 to create the DNN 190 and to perform at least the auto scaling enabled training for process 120. The one or more computer systems 140 may comprise a number of graphics processing units (GPUs) 180, which implement the DNN 190 and the corresponding process 120. Alternatively or in addition, the one or more computer systems may comprise a single central processing unit (CPU) 185, such as a multi-core processor. For instance, the single CPU 185 could program the GPUs 180 with the calculations and configuration for the DNN 190, and the single CPU 185 could coordinate the operations performed and gathered results for FIGS. 2-4, but the GPUs 180 would perform the required mathematical manipulations and analyses. As another example, the single CPU 185 could both simulate the DNN 190 and perform the corresponding process 120, without the use of the GPUs 180. As a further example, alternatively or in addition to one or both of the GPUs 180 and the single CPU 185, multiple CPU clusters 195 may be used to both simulate the DNN 190 and perform the corresponding process 120. The CPU clusters 195 comprise clusters of CPU(s) together with memory and are linked via hardware such as networks. For instance, such CPU clusters 195 could be computer systems on the cloud.

Furthermore, although it is expected that the DNN 190 would not be implemented as a low power DNN platform 130 until after the process 120 is performed and the trained fixed point (or fix-point) DNN 125 has been created, it is also possible to both simulate the DNN 190 and perform the corresponding process 120 in circuitry 197, such as an FPGA 197-1, an ASIC 197-2, and/or a neuromorphic chip 197-3. This may be performed as an alternative to operations performed the computer system(s) 140 or in addition to those.

Turning to FIG. 2, this figure is a logic flow diagram for multi stage auto scaling enabled training. This figure illustrates the operation of an exemplary method, a result of execution of computer program instructions embodied on a computer readable memory, functions performed by logic implemented in hardware, and/or interconnected means for performing functions in accordance with exemplary embodiments. In this example, the blocks 205, 215, 220, 230, and 235 in the process 120 are performed by a typical DNN, and blocks 210 and 225 in process 120 are new blocks added in accordance with the exemplary embodiments herein.

The flow for the auto scaling of DNNs process 120 starts in block 205, and in block 210, the scaling factors are initialized. The scaling factors for each neural network layer are initialized empirically. In an example, a reasonable number is used as a starting point of the scaling factor of each layer. Reasonable means the number is within the upper and lower bound and in most cases, the number will not make the network instable. In block 215, the training parameters are set. Setting the training parameters include at least deploying the initialized or updated scaling factors to be used for the subsequent training in block 220. In block 220, the DNN is trained (e.g., using samples from the dataset 110). In block 225, the scaling factors are updated, e.g., through multiple stages of auto scaling, described below. In block 230, it is determined whether the training is finished. If not (block 230=No), the process 120 proceeds to block 215. If the training is finished (block 230—Yes), the process 120 ends in 235. At this point, the output is the trained fixed point DNN 125.

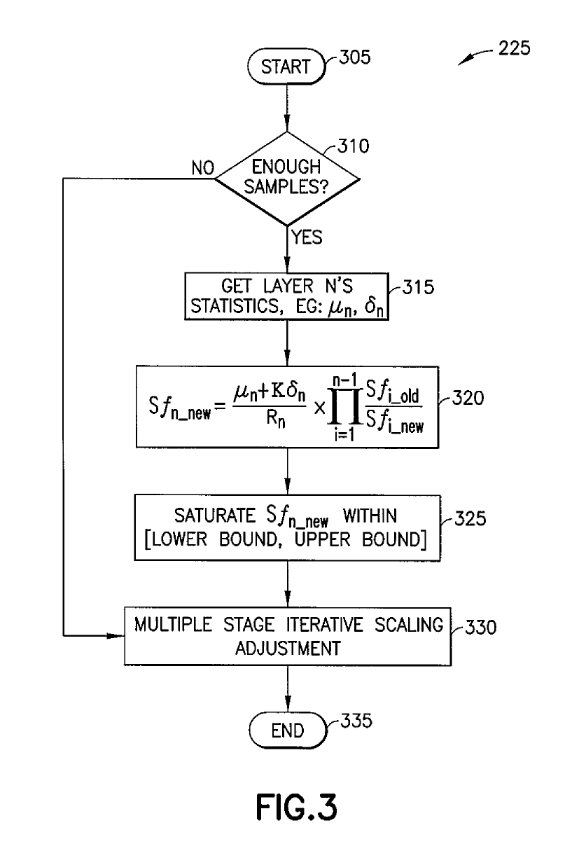

FIG. 3 is a logic flow diagram for updating scaling factors. This figure also illustrates the operation of an exemplary method, a result of execution of computer program instructions embodied on a computer readable memory, functions performed by logic implemented in hardware, and/or interconnected means for performing functions in accordance with exemplary embodiments.

Before proceeding with additional detail regarding the auto scaling enabled training used herein, it is helpful to review additional description regarding the scaling factor. Simplistically, a scaling factor, Sf, is used to convert a floating point number to a fixed point number, which is essential in fixed-point implementations, e.g., using the following:

$$Fix = round ( \frac{Float}{Sf} ) .$$

If the bit width is W for a fixed point number, then the range of a signed fixed point number is (−2^{(W-1)}, 2^{(W-1)}−1), and the range of unsigned fixed point number is (0,2^{W}−1).

The fixed point number needs to be saturated within the range decided by its bit width. If one knows the range of float and fix, usually Sf, can be decided as follows:

$$Sf = \frac{max ( \vert Float \vert )}{max ( \vert range ( Fix ) \vert )} .$$

For example, if one knows the floating point number to be express is from −1024 to 1024 and will be expressed by a 3-bit fixed point number (able to represent −4:3), then a good scaling factor could be

$$Sf = \frac{1024}{4} = 256$$

(as the maximum for the fixed point number is −4).

In real situations, usually one cannot determine the maximum of floating point numbers because this maximum is random. Also one does not want to lose the accuracy such that a rare big number cannot be expressed. Hence, another good way to estimate the maximum for a floating point number is to determine the statistical information of the floating point number. Usually if the data size is large enough, it can be assumed that the distribution will be Gaussian like. In DNNs, the parameters can be in the millions, which is quite large. The techniques below therefore use statistical information for the floating point numbers in order to determine the scaling factors.

The process 225 starts in block 305, and in block 310, it is determined if there are enough samples to perform updating of the scaling factors. Auto scaling will be carried out when enough training samples have been used for training. This could be every N samples, where N should be large enough, such as 0.1˜1× (from 10 percent to all) of whole training samples. Using too small N will cause scaling factor adjustment become jittering. If there are not enough samples (block 310=No), the process 225 ends in block 335. Otherwise, if there are enough samples (block 310=Yes), the process 225 continues in block 315.

In block 315, statistics for the layer n are determined. As stated above, a DNN 190 has multiple layers, and each layer has its input and output. In block 315, collection of all the output of each DNN layer is performed (e.g., by the controller 170). After training with enough samples (see block 310), the mean and standard deviation are calculated (e.g., again by the controller 170) for each layer.

This step is specially designed to get the suitable scaling factor, which is not required for traditional pure float point DNN training. These statistics are the mean, μₙ, and the standard deviation, δₙ as illustrated in block 315 and used below.

In block 320, a scaling factor, Sf, is calculated based on each layer's statistical information. The bit width of each layer's filter is predefined (e.g., a hyper parameter). Only one scaling factor is needed for each layer to decide on output. A new scaling factor, Sfₙ_{_}_{new}, is determined via the following equation, in an exemplary embodiment, which is a layer by layer adaption of the scaling factors:

$${Sf}_{n \_ new} = \frac{{μ}_{n} + K {δ}_{n}}{{R}_{n}} \times {\prod }_{i = 1}^{n - 1} \frac{{Sf}_{i \_ old}}{{Sf}_{i \_ new}} ,$$

where:

$${Sf}_{1 \_ new} = \frac{{μ}_{1} + K {δ}_{1}}{{R}_{1}} ;$$

μₙ is a mean of the floating point numbers used for the layer n;

δₙ is a standard deviation of the floating point numbers used for the layer n;

K is used to control a range of floating point numbers (a typical value might be four);

Rₙ: is a range of fixed point numbers for the layer n;

old indicates a previous value; and

new indicates a current value.

The range Rₙ is decided by the fixed number's bit width. For instance, if we use seven digits to represent the floating point numbers for a particular layer, then the range is 64 (=2^{(x-1)}, where x in this case is the number of digits, seven). That is, seven digits can represent −64˜63 (negative 64 to positive 63, assuming signed integers). The range can be set per layer or per all layers.

It should be noted that the scaling factor for a layer such as layer 3 (=n) depends on the (old and new) scaling factors for previous layers 1 and 2. This is true because if one modifies the scaling factor in the previous layer, the following layer's data distribution is also changed. The previous equation considers the chained change. For example, if one uses a scaling factor of two instead of four for layer 1, then layer 1's output will be twice as large. Then layer 2's output will also be twice as large if one did not modify layer 2's scaling factor. This is an important point to make the scaling factor adjustment stable.

It should also be noted that using the mean and standard deviation to represent the statistical information of each layer's output is just one example, and other techniques are possible. For instance, in Matthieu Courbariaux, Jean-Pierre David, Yoshua Bengio, “Training Deep Neural Networks With Low Precision Multiplications”, arXiv:1511.00363 (2016), this reference uses overflow rate, which is another possibility. In the Courbariaux reference, they used dynamic fixed point (and an overflow rate) and updated the scaling factors once every 10000 examples. See, e.g., the Algorithm 2, Policy to update a scaling factor, in Section 5, entitled “DYNAMIC FIXED POINT”. Such an algorithm could be adapted for use here, but with the above layer by layer adaption of the scaling factors, where a scaling factor for one layer depends on the scaling factors for previous layers (e.g., determining the scaling factor for a selected layer, which is at a position in an order of layers from a starting layer to an ending layer in a DNN, is based on scaling factors used in layers in the order prior to the position of the selected layer).

Additionally, one can always find different ways to represent the statistical information. For example, one can use variance instead of standard deviation; for mean, this can be replaced by a middle value (median). Other techniques are also possible.

In block 325, the scaling factor, Sfₙ_{_}_{new}, is saturated within [lower bound, upper bound]. That is, the scaling factor will be set to the lower bound if the scaling factor is less than the lower bound, or will be set to the upper bound if the scaling factor is greater than the upper bound. The bounds are typically predefined parameters, such as in an exemplary embodiment the bound can be specified for each layer. Alternatively, the bounds could be the same for all the layers. In block 330, there is a multiple stage scaling adjustment, described below. The flow 225 ends in block 335.

The multiple stage scaling adjustment in block 330 may be performed as follows. Typically, large steps are employed at the beginning iterations of the updating of the scaling factor, and then smaller steps are performed in later iterations. Finally, scaling adjustment can be disabled to achieve a stable training performance. An implementation example is as follows:

Sfₙ_{_}_{new}=Sfₙ_{_{old}}+a(Sfₙ_{_{new}}−Sfₙ_{_{old}}),(0≤a≤1).

The variable a can be used to control the adjusting speed for different stages of iterations. In the beginning iteration(s), a could be 1, then 0.5, then 0.1 and so on. In a fixed stage, a can be 0 (zero). The fixed stage is when the adjusting speed is no longer being adjusted, which typically occurs in the later iterations.

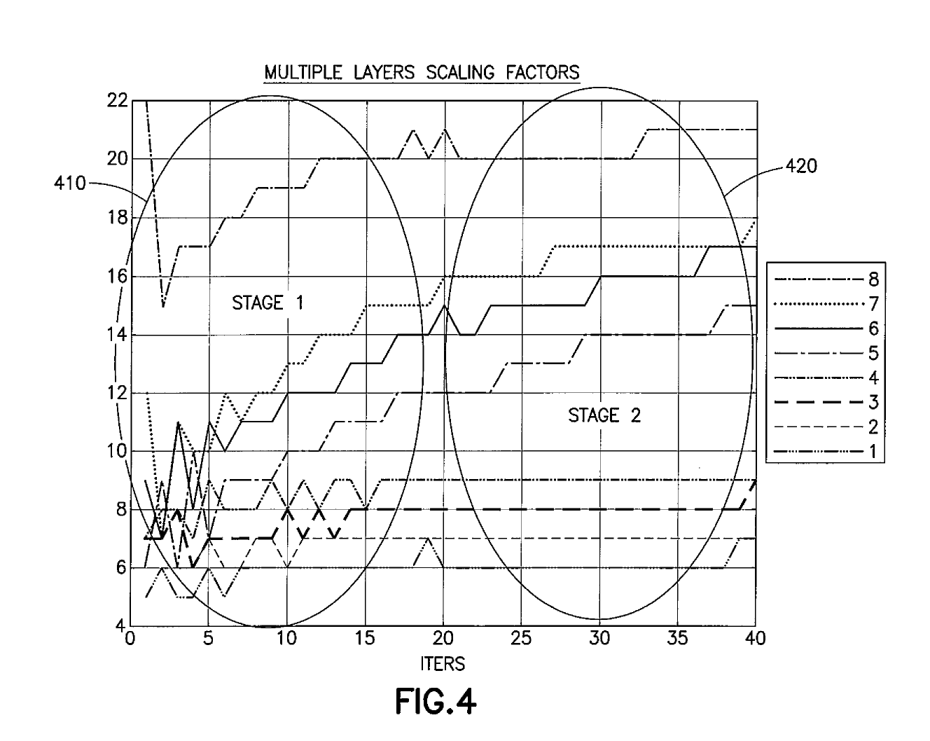

FIG. 4 illustrates an example of multiple stage scaling adjustment. There are eight scaling factors 1-8 on the diagram. Forty iterations (iters) are illustrated on the abscissa, and the values for the multiple layers scaling factors are illustrated on the ordinate. Two stages 410 (Stage 1) and 420 (Stage 2) are shown. The variable a is a higher value in Stage 1 410, which allows for more variation over iterations in the scaling factors 1-8. The variable a is a lower value in Stage 2 420, which allows for less variation over iterations in the scaling factors 1-8.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method, comprising:
performing automatic scaling on a floating point implementation of a deep neural network to perform scaling to a fixed point implementation of the deep neural network, wherein the deep neural network comprises a plurality of layers in an order from a starting layer to an ending layer and uses floating point calculations in the plurality of layers, the automatic scaling comprising:
determining a scaling factor for each of multiple ones of the layers during training of the deep neural network, wherein the scaling factor converts floating point numbers used for calculations in a corresponding layer into integer numbers to be used in the calculations, and wherein determining a scaling factor comprises determining the scaling factor for a selected layer, which is at a position in the order, based on scaling factors used in layers in the order prior to the position of the selected layer; and
outputting the scaling factors for the multiple layers to be used for implementing the fixed point implementation of the deep neural network, wherein the fixed point implementation of the deep neural network uses integer calculations instead of floating point calculations.

2. The method of claim 1, wherein the automatic scaling further comprises, prior to determination of any of the scaling factors, initializing the scaling factors with scaling factors set empirically.

3. The method of claim 2, wherein:
the automatic scaling further comprises:
setting training parameters to implement current scaling factors, initially using the scaling factors set empirically and subsequently using updated scaling factors;
performing the training on the deep neural network using samples from at least one data set;
updating the scaling factors by performing the determining the scaling factors, in order to determine the updated scaling factors; and
performing iterations of the setting the training parameters, performing the training, and updating the scaling factors until it is determined the training of the deep neural network is finished; and
the outputting is performed in response to the determination the training of the deep neural network is finished.

4. The method of claim 3, wherein updating the scaling factors is performed only after a predetermined number of samples have been used from the at least one data set for training.

5. The method of claim 3, wherein determining the scaling factor further comprises determining the scaling factor for the selected layer at the position in the order based on scaling factors used in layers in the order prior to the position of the selected layer and based on one or more statistics of the selected layer.

6. The method of claim 5, wherein determining the scaling factor further comprises determining the scaling factor for the first layer based only on one or more statistics of the first layer and not on scaling factors for any other layers.

7. The method of claim 3, wherein determining the scaling factor further comprises determining a scaling factor for a layer n using the following equation:
$${Sf}_{n \_ new} = \frac{{μ}_{n} + K {δ}_{n}}{{R}_{n}} \times {\prod }_{i = 1}^{n - 1} \frac{{Sf}_{i \_ old}}{{Sf}_{i \_ new}} ,$$
where:
$${Sf}_{1 \_ new} = \frac{{μ}_{1} + K {δ}_{1}}{{R}_{1}} ;$$
Sf is a scaling factor;
μₙ is a mean of floating point numbers used for the layer n;
δₙ is a standard deviation of floating point numbers used for the layer n;
K is used to control a range of floating point numbers;
Rₙ: is a range of fixed point numbers for the layer n;
old indicates a previous value; and
new indicates a current value.

8. The method of claim 8, wherein a value for K is four.

9. The method of claim 3, wherein the scaling factors for each iteration and each layer are saturated within a corresponding lower bound and a corresponding upper bound.

10. The method of claim 3, further comprising performing a multiple stage iterative scaling adjustment to the scaling factors over multiple iterations.

11. The method of claim 10, wherein performing a multiple stage iterative scaling adjustment to the scaling factors over multiple iterations further comprises applying the following formula to the scaling factors:
Sfₙ_{_}_{new}=Sfₙ_{_{old}}+a(Sfₙ_{_{new}}−Sfₙ_{_{old}}),(0≤a≤1),
where:
Sf is a scaling factor;
n is a layer;
old indicates a previous value; and
new indicates a current value; and
the variable a is used to control adjusting speed for different stages of iterations.

12. The method of claim 11, wherein in beginning iterations, a is a higher value than is a value for a used in later iterations.

13. The method of claim 1, further comprising implementing the fixed point implementation of the deep neural network in circuitry using the output scaling factors.

14. The method of claim 13, wherein the circuitry comprises a field-programmable gate array, or an application-specific integrated circuit, or a neuromorphic chip.

15. An apparatus comprising:
one or more memories comprising a computer readable program; and
one or more processors, wherein the one or more processors are configured, in response to executing the computer readable program, to cause the apparatus to perform operations comprising:
performing automatic scaling on a floating point implementation of a deep neural network to perform scaling to a fixed point implementation of the deep neural network, wherein the deep neural network comprises a plurality of layers in an order from a starting layer to an ending layer and uses floating point calculations in the plurality of layers, the automatic scaling comprising:
determining a scaling factor for each of multiple ones of the layers during training of the deep neural network, wherein the scaling factor converts floating point numbers used for calculations in a corresponding layer into integer numbers to be used in the calculations, and wherein determining a scaling factor comprises determining the scaling factor for a selected layer, which is at a position in the order, based on scaling factors used in layers in the order prior to the position of the selected layer; and
outputting the scaling factors for the multiple layers to be used for implementing the fixed point implementation of the deep neural network, wherein the fixed point implementation of the deep neural network uses integer calculations instead of floating point calculations.

16. The apparatus of claim 15, wherein the one or more processors comprise at least one of the following: one or more graphics processing units; one or more central processing units (CPUs); and one or more CPU clusters.

17. The apparatus of claim 15, wherein the automatic scaling further comprises, prior to determination of any of the scaling factors, initializing the scaling factors with scaling factors set empirically.

18. The apparatus of claim 17, wherein:
the automatic scaling further comprises:
setting training parameters to implement current scaling factors, initially using the scaling factors set empirically and subsequently using updated scaling factors;
performing the training on the deep neural network using samples from at least one data set;
updating the scaling factors by performing the determining the scaling factors, in order to determine the updated scaling factors; and
performing iterations of the setting the training parameters, performing the training, and updating the scaling factors until it is determined the training of the deep neural network is finished; and
the outputting is performed in response to the determination the training of the deep neural network is finished.

19. The apparatus of claim 18, wherein updating the scaling factors is performed only after a predetermined number of samples have been used from the at least one data set for training.

20. The apparatus of claim 18, wherein determining the scaling factor further comprises determining the scaling factor for the selected layer at the position in the order based on scaling factors used in layers in the order prior to the position of the selected layer and based on one or more statistics of the selected layer.

21. The apparatus of claim 20, wherein determining the scaling factor further comprises determining the scaling factor for the first layer based only on one or more statistics of the first layer and not on scaling factors for any other layers.

22. The apparatus of claim 18, wherein determining the scaling factor further comprises determining a scaling factor for a layer n using the following equation:
$${Sf}_{n \_ new} = \frac{{μ}_{n} + K {δ}_{n}}{{R}_{n}} \times {\prod }_{i = 1}^{n - 1} \frac{{Sf}_{i \_ old}}{{Sf}_{i \_ new}} ,$$
where:
$${Sf}_{1 \_ new} = \frac{{μ}_{1} + K {δ}_{1}}{{R}_{1}} ;$$
μₙ is a mean of floating point numbers used for the layer n;
δₙ is a standard deviation of floating point numbers used for the layer n;
K is used to control a range of floating point numbers;
Rₙ: is a range of fixed point numbers for the layer n;
old indicates a previous value; and
new indicates a current value.

23. The apparatus of claim 22, wherein a value for K is four.

24. The apparatus of claim 18, wherein the scaling factors for each iteration and each layer are saturated within a corresponding lower bound and a corresponding upper bound.

25. The apparatus of claim 18, wherein the one or more processors are further configured, in response to executing the computer readable program, to cause the apparatus to perform operations comprising: performing a multiple stage iterative scaling adjustment to the scaling factors over multiple iterations.

26. The apparatus of claim 25, wherein performing a multiple stage iterative scaling adjustment to the scaling factors over multiple iterations further comprises applying the following formula to the scaling factors:
Sfₙ_{_}_{new}=Sfₙ_{_{old}}+a(Sfₙ_{_{new}}−Sfₙ_{_{old}}),(0≤a≤1),
where:
Sf is a scaling factor;
n is a layer;
old indicates a previous value; and
new indicates a current value; and
the variable a is used to control adjusting speed for different stages of iterations.

27. The apparatus of claim 26, wherein in beginning iterations, a is a higher value than is a value for a used in later iterations.

28. The apparatus of claim 15, wherein the one or more processors are further configured, in response to executing the computer readable program, to cause the apparatus to perform operations comprising: implementing the fixed point implementation of the deep neural network in circuitry using the output scaling factors.

29. The apparatus of claim 28, wherein the circuitry comprises a field-programmable gate array, or an application-specific integrated circuit, or a neuromorphic chip.

30. A deep neural network formed in circuitry based on a method comprising:
performing automatic scaling on a floating point implementation of a deep neural network to perform scaling to a fixed point implementation of the deep neural network, wherein the deep neural network comprises a plurality of layers in an order from a starting layer to an ending layer and uses floating point calculations in the plurality of layers, the automatic scaling comprising:
determining a scaling factor for each of multiple ones of the layers during training of the deep neural network, wherein the scaling factor converts floating point numbers used for calculations in a corresponding layer into integer numbers to be used in the calculations, and wherein determining a scaling factor comprises determining the scaling factor for a selected layer, which is at a position in the order, based on scaling factors used in layers in the order prior to the position of the selected layer; and
outputting the scaling factors for the multiple layers to be used for implementing the fixed point implementation of the deep neural network, wherein the fixed point implementation of the deep neural network uses integer calculations instead of floating point calculations.

31. The deep neural network of claim 30, wherein the circuitry comprises a field-programmable gate array, or an application-specific integrated circuit, or a neuromorphic chip.
